(19) United States
(12) Patent Application Publication
(10) Pub. No.: US 2020/0132198 A1
(43) Pub. Date: Apr. 30, 2020

(54) Sealing Assembly for a Turbomachine

(71) Applicant: MTU Aero Engines AG, Muenchen (DE)

(72) Inventors: Beate Schleif, Muenchen (DE); Daniel Greitemeier, Muenchen (DE)

(21) Appl. No.: 16/663,662

(22) Filed: Oct. 25, 2019

(30) Foreign Application Priority Data
Oct. 30, 2018 (DE) 102018218604.9

(51) Int. Cl. F16J 15/44; F02C 7/28

(52) U.S. Cl. CPC F16J 15/444; B33Y 80/00; F02C 7/28

(57) ABSTRACT

A sealing assembly (23) for a turbomachine (1) having a seal carrier (24) and a seal structure (30) configured on the seal carrier (24), the seal structure (30) having additively built-up projections (32) that extend in each case away from the seal carrier (24) to a free end (32.1), the projections (32) being constructed in each case to have a varying cross-sectional profile, namely a particular projection (32) in a section (33) that is distal to the seal carrier (24) having a smaller thickness (34) at the free end (32.1) than in a section (35) that is proximal to the seal carrier (24).

This claims the benefit of German Patent Application DE 10 2018 218 604.9, filed Oct. 30, 2018 which is hereby incorporated by reference herein.

### FIELD OF THE INVENTION

The present invention relates to a sealing assembly for a turbomachine.

### BACKGROUND INFORMATION

The turbomachine may be a jet engine, such as a turbofan engine, for example. The turbomachine is functionally divided into a compressor, a combustion chamber and a turbine. In the case of the jet engine, for instance, intake air is compressed by the compressor and burned with added jet fuel in the downstream combustion chamber. The resulting hot gas, a mixture of combustion gas and air, flows through the downstream turbine and is thereby expanded. The turbine also thereby proportionally extracts energy from the hot gas to drive the compressor. Generally, the turbine and the compressor each have a multi-stage design, each stage having a guide vane ring and a rotor blade ring.

In a turbomachine, various components are moved relative to each other; depending on the component, a relative sealing against differential pressures also possibly being required. In this context, what are generally referred to as honeycomb seals are used. They are joined by spot welding sheet-metal strips and are brazed onto a seal carrier, so that the honeycombs form cavities that are open to a side opposite the seal carrier. From this side, a sealing part, which is moved in operation relatively thereto, extends as a counterpart to the seal structure, often referred to as a sealing tip or fin.

### SUMMARY OF THE INVENTION

It is a technical object of the present invention to provide an especially advantageous sealing assembly.

The present invention provides a sealing assembly. The seal structure thereof has additively built-up projections, which are thus manufactured as 3D printed parts. As discussed in detail in the following, on the one hand, the projections may be web walls, which, analogously to the explanation at the outset, together, define cavities, which are open on one side. On the other hand, the projections may also be struts that are embedded in a filler material. In any case, the projections are constructed layer by layer of a previously amorphous or shape-neutral material on the basis of a data model which allows for freedom of form design. In the case of the web walls, for example, also possible are geometries which deviate from the (regular) honeycomb form and are able to be optimized for the sealing function, for example.

In accordance with the present invention, the projections are thereby built up to have varying cross-sectional profiles, namely in a section that is proximal to (near) the seal carrier that is larger in width or thickness than in a section that is distal to (further from) the seal carrier. The projections extend away from the seal carrier, in each case toward a free end; the distal section is contiguous thereto. The smaller wall thickness there is advantageous in terms of a rubbing contact, when, during operation, for example, the sealing tip, respectively the fin runs into the seal structure, abrading the same to a certain degree. In this respect, the reduced thickness of the projections there results in an effective running-in behavior.

On the other hand, the greater thickness in the proximal section may be advantageous in terms of stability, for example, with regard to the flexural, respectively vibration strength of the attachment to the seal carrier. In comparison to other production methods, additive manufacturing may produce intrinsic defect sites with a somewhat higher probability, which, in the worst case, when loaded during operation, could lead to a macroscopic damaged area and, thus, to a component failure. By increasing the thickness and thus the material thickness in the mechanically stressed area at the transition to the seal carrier; in simplified terms, there is still sufficiently intact material available for a reliable attachment, even in the case of an intrinsic defect site.

Preferred embodiments will become apparent from the dependent claims and the entire Specification, a distinction not always being made in detail between the sealing assembly and the turbomachine, respectively the corresponding module in the description of the features; at any rate, the disclosure is to be read implicitly with regard to all claim categories. The designations “proximal” and “distal” denote the relative mutual position of the sections and thereby relative to the seal carrier, thus, the proximal section is closer to the seal carrier than is the distal section.

If the cross-sectional profile of a particular projection is considered, thus, a section along the vertical extent thereof from the seal carrier to the free end of the projection, the thickness in this section is taken orthogonally to the vertical extent. In the case of the struts, in particular, the projections may also be tilted relative to each other, forming undercuts (good hold for the filler material) (for the illustration, see FIG. 5). With regard to the vertical directions thereof, the web walls may preferably be disposed parallel to each other; relative to the installation position, the vertical direction may then preferably be radially oriented (“radial” refers to the axis of rotation of the rotor blade ring(s), which generally coincides with a longitudinal axis of the turbomachine).

In the case of the web walls, the “thickness of the projection” corresponds to the wall thickness of the web wall. In a plan view, thus looking at the web walls from the side opposite the seal carrier, these web walls may form a regular or also irregular grid. In simple variants, rectangles, in particular squares, may be joined to each other; however, more complex structures are also possible. Additive manufacturing may be used for regular hexagons to produce a classic honeycomb form, as it is equally for modified forms, for example, elongated honeycombs or also squares, etc. Likewise possible are completely irregular, for example, stochastically produced structures. The latter may also be of interest in the case of the struts. It is intended here that various options be presented; in the case at hand, however, a cross-sectional profile that is suited for additive manufacturing and allows for this geometric diversity of design is rather to be provided.

The manufacturing described at the outset by brazing on sheet-metal strips is not only limited in a geometrical respect, but is also expensive. Various handling and manipulation steps are needed. They are at least able to be reduced by additive manufacturing. It is preferred that not only the seal structure including the projections, but also the seal carrier be built-up additively; the seal carrier and the seal structure are preferably produced together in the same manufacturing process. Generally, the seal structure, respectively the sealing assembly may be constructed of a nickel or cobalt alloy. The sealing part (sealing tip) may be made of a nickel, titanium, cobalt or iron alloy, for example; an intermetallic alloy is likewise possible.

The geometric form of the projections is discussed further in detail in the following; this disclosure referring both to the embodiment as web walls, as well as to the struts.

In accordance with a preferred specific embodiment, the projections have a constant thickness in the distal section. This may be advantageous in terms of the most uniform possible abrasive wear characteristics, for example. Likewise, with regard to running-in, a thickness of at most 250 μm may be preferred in the distal section; further advantageous upper limits being at most 225 μm and 200 μm. With regard to mechanical stability, lower limits may be at least 50 μm, 75 μm, respectively 100 μm, for example.

In an preferred specific embodiment, the projection(s) in the proximal section has/have a maximum thickness that corresponds to at least three times the average, respectively constant thickness in the distal section. Possible upper limits may be at most seven, six, respectively five times. Generally speaking, the projection typically reaches the maximum thickness thereof where it merges into the seal carrier.

In a preferred embodiment, the proximal section constitutes at most half, preferably at most one third of the height of the projection. Limiting the thicker section may be advantageous, for example, in terms of an altogether weight-optimized design. A possible lower limit for the extent of the proximal section is at least ⅙ of the height, for example.

In a preferred specific embodiment, the projection(s) run(s) in each case by a fillet into the seal carrier. In particular, a fillet composed of a plurality of radii may be advantageous. This may be favorable in terms of structural, respectively vibration mechanics, for example. Forms of this kind are also readily available in additive manufacturing.

As already mentioned at the outset, in a preferred specific embodiment, the projections are struts, thus pins that extend away from the seal carrier. These struts, respectively pins are embedded in a filler material, respectively run-in coating. They hold the filler material on the seal carrier. The filler material may be a polymer material, for example. An inorganic filler material, for example, inorganic hollow spheres are likewise possible.

In another preferred specific embodiment, the projections are web walls and thus have an elongated form disposed orthogonally to the vertical direction. Together, the web walls define cavities, which are open in each case to the side opposite the seal carrier (see above).

In a preferred embodiment, such a web wall is formed as a solid body. Thus, it extends without discontinuity between the mutually opposing outer wall surfaces thereof, thus it is free of cavities, for example, on the inside. This may be advantageous, for instance, with regard to the structural sizes relevant here, for example, in terms of manufacturability. In particular, by limiting the height of the proximal section and also the maximum thickness of the same, an altogether weight-optimized structure may nevertheless result.

The present invention also relates to a module for a turbomachine that has a sealing assembly discussed herein and, in addition, a sealing part that moves during operation relative to the sealing assembly. The sealing part may preferably be a sealing tip, respectively fin. The sealing assembly is preferably part of an inner air seal, thus it is configured radially inside of the gas duct. In the case of the turbine, the gas duct is the hot gas duct thereof; on the other hand, in the case of the compressor, it is the compressor gas duct.

A design is preferred where the sealing assembly is suspended radially within an inner platform of a guide vane ring. For this purpose, the sealing assembly may be assembled in the form of what is commonly known as a spoke centering using a pin that extends radially inwardly from the inner platform. Regardless of the type of suspension, the sealing assembly along with the seal structure thereof is specifically fixed in position relative to the guide vane ring. The sealing part, respectively the sealing tip then rotates together with a rotor blade ring; it is self-evident that a plurality of sealing tips may also be provided in axial succession. In the case of the web walls, the cavities formed by the seal structure are not filled; thus there is no filler material therein.

The present invention also relates to a turbomachine having a sealing assembly as disclosed herein, respectively a corresponding module. The turbomachine may preferably be an aircraft engine, for example, a turbofan engine.

The present invention also relates to a method for manufacturing such a sealing assembly, respectively the module or the turbomachine, projections of the seal structure being built-up additively. The seal carrier and the projections are preferably built-up together (see above), the build-up direction preferably being toward the free ends of the projections (thus, first the seal carrier and then the seal structure are built up). The additive building up may preferably be carried out in a powder bed process, the material being sequentially deposited layer by layer in powder form. Depending on the layer, a predetermined area is selectively solidified on the basis of the data model of the component geometry. The solidification is performed by a fusion process using a radiation source, for instance, an electron beam source or preferably a laser source, which is also referred to as selective laser melting (SLM).

### BRIEF DESCRIPTION OF THE DRAWINGS

The present invention is explained in greater detail in the following with reference to an exemplary embodiment; within the scope of the coordinated independent claims, the individual features possibly being essential to the present invention in other combinations as well, and, as above, no distinction being specifically made among the different claim categories.

In the drawing,

FIG. 1 shows an axial cross-sectional view of a jet engine;

FIG. 2 shows a cut-away portion of a module of the jet engine, namely an inner air seal;

FIG. 3 shows a detail view of a seal structure as part of the inner air seal;

FIG. 4a-e show various options for designing the cavities including a seal structure having web walls;

FIG. 5 shows a seal structure constructed from struts.

### DETAILED DESCRIPTION

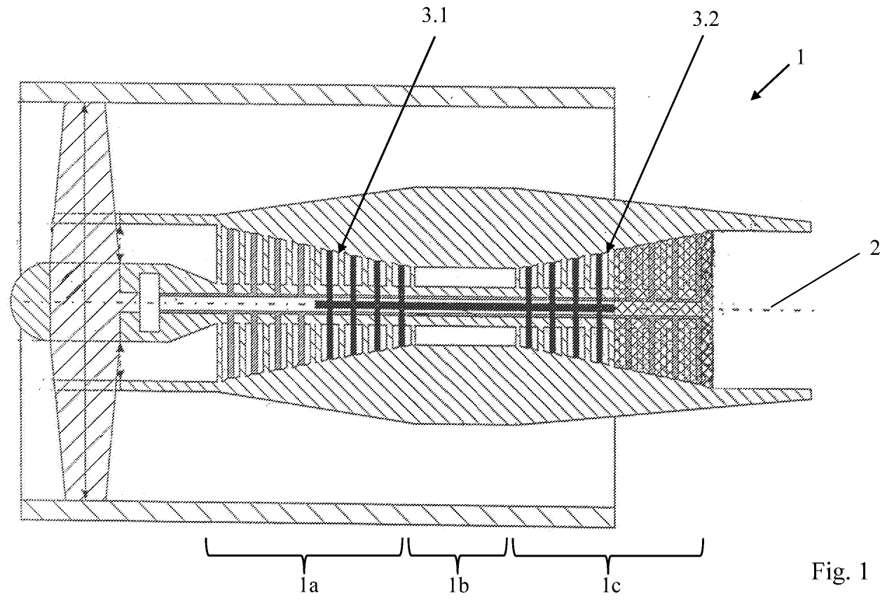

In a schematic, axial cross-sectional view (relative to a longitudinal axis 2), FIG. 1 shows a turbomachine 1, specifically a turbofan engine. Turbomachine 1 is functionally divided into a compressor 1a, a combustion chamber 1b and a turbine 1c. Both compressor 1a and turbine 1c are thereby made up of a plurality of stages in each case; each stage is composed of a guide vane ring and rotor blade ring. Upstream of combustion chamber 1b, the intake air is compressed in a compressor gas duct 3.1; the expansion taking place in downstream hot gas duct 3.2.

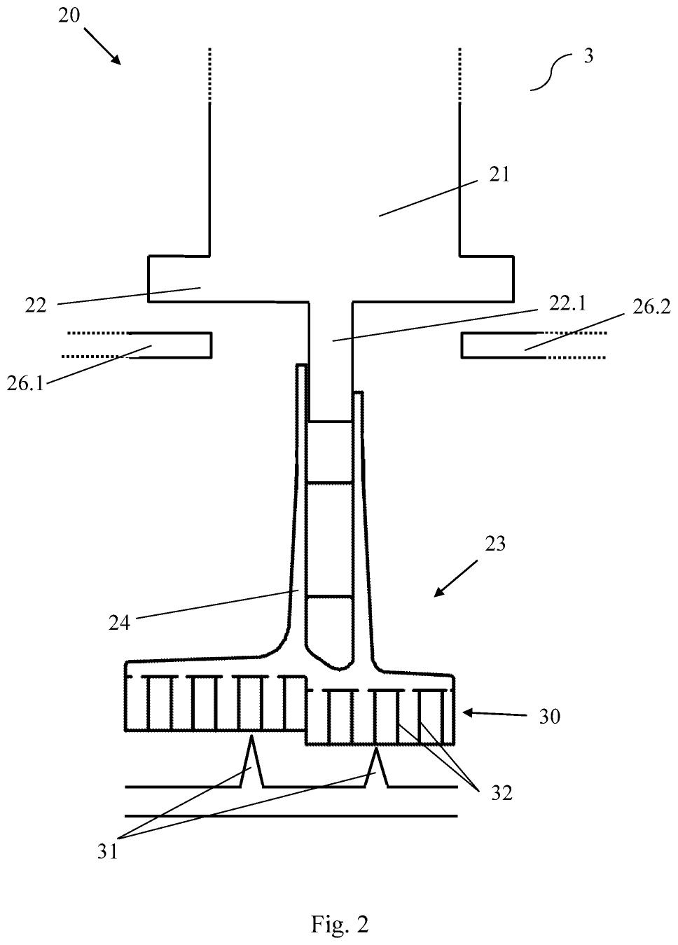

FIG. 2 illustrates a cut-away portion of a module 20, which, in this form, may be provided both in compressor 1a, as well as in turbine 1c. Discernible is a guide vane 21, which has an inner platform 22 and is configured in gas duct 3. Extending radially inwardly from inner platform 22 is a pin 22.1 which is used to assemble a sealing assembly 23 in the form of what is commonly known as spoke centering. Pin 22.1 and a seal carrier 24 of sealing assembly 23 may be riveted to one another, for example. Also discernible are respective inner platforms 26.1, 26.2 of the upstream, respectively downstream rotor blade ring.

Particularly of interest in the present case is the design of a seal structure 30, which is configured radially inwardly on seal carrier 24 and against which sealing parts 31, which rotate during operation, namely sealing tips (fins) seal. Seal structure 30 is constructed from projections 32, which are built-up additively together with seal carrier 24. The manufacturing is carried out here in a powder bed process, the build-up direction being radially inward, thus downward in FIG. 2.

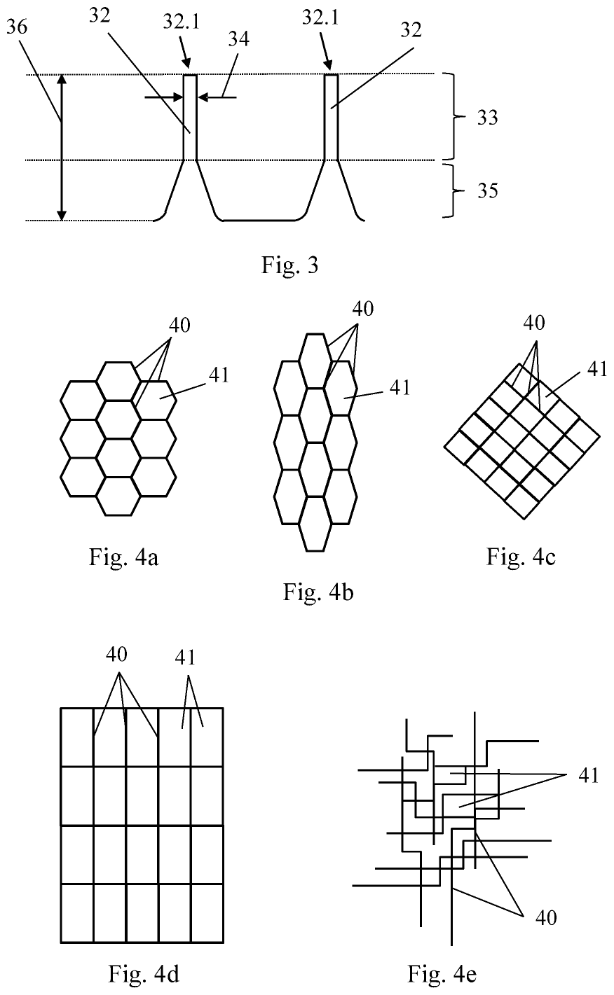

FIG. 3 shows two projections 32 in a schematic sectional view (rotated by 180° relative to FIG. 2). In a distal section 33 at free ends 32.1 of projections 32, respective thickness 34 thereof is about 150 μm in each instance. Distal section 33 extends over ⅔ of a height 36 of projections 32. In proximal section 35 that is contiguous thereto and disposed toward seal carrier 24, thickness 34 increases to about 500 μm. The thicker proximal section 35 provides a good mechanical attachment; on the other hand, distal section 33 serves as an abradable portion into which the sealing tips may run.

Projections 32 may be formed as web walls; thus, relative to FIG. 3, they extend in elongated form upstream and downstream of the cross-sectional plane. FIG. 4a-e show such variants, in each case in a plan view, thus, from radially inwardly relative to the configuration in accordance with FIG. 2. Discernible, on the one hand, are web walls 40 and, on the other hand, radially inwardly open cavities 41 defined by the same. In the variant in accordance with FIG. 4a, web walls 40 form regular hexagons, thus a conventional honeycomb pattern. FIG. 4b-e illustrate the options that are made possible by additive manufacturing; a variation of the honeycomb form is possible (FIG. 4b); likewise possible are also other regular geometries (FIG. 4c, d) or even completely irregular configurations (FIG. 4e).

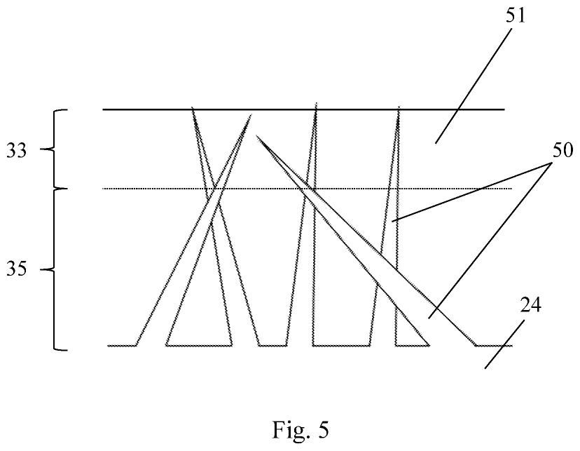

FIG. 5 shows a variant where projections 32 are pin-shaped struts 50. Struts 50 hold a filler material 51, namely polymer material as a run-in coating on seal carrier 24. Abrasion therefrom may take place during the run-in process in an area opposite seal carrier 24, together with distal sections 33 of struts 50.

### LIST OF REFERENCE NUMERALS

turbomachine 1
compressor 1a
combustion chamber 1b
turbine 1c
longitudinal axis 2
gas duct 3
compressor gas duct 3.1
hot gas duct 3.2
module 20
guide vane 21
inner platform 22
pin 22.1
sealing configuration 23
seal carrier 24
inner platform 26.1, 26.2
seal structure 30
sealing part (sealing tip) 31
projections 32
free ends 32.1
distal section 33
thickness 34
proximal section 35
height 36
web walls 40
cavities 41
struts or struts 50
filler material 51

What is claimed is:

1-15. (canceled)

16. A sealing assembly for a turbomachine comprising:
a seal carrier; and
a seal structure configured on the seal carrier, the seal structure having additively built-up projections extending in each case away from seal carrier to a free end, the projections each being constructed to have a varying cross-sectional profile, namely a respective projection of the projections having a smaller thickness at the free end in a distal section distal from seal carrier than in a proximal section proximal to the seal carrier.

17. The sealing assembly as recited in claim 16 wherein the thickness of the respective projection in the distal section is constant.

18. The sealing assembly as recited in claim 16 wherein the thickness of the respective projection in the distal section is at least 50 μm and not more than 250 μm.

19. The sealing assembly as recited in claim 16 wherein the respective projection has a maximum thickness in the proximal section corresponding to at least three times the average thickness in the distal section.

20. The sealing assembly as recited in claim 16 wherein the proximal section extends over at least ⅙ and at most ½ of a height taken toward the free end of the respective projection.

21. The sealing assembly as recited in claim 16 wherein the respective projection has a height of at least 2 mm and of at most 6 mm taken from the free end.

22. The sealing assembly as recited in claim 16 wherein, via a fillet composed of a plurality of radii, the respective projection runs into the seal carrier.

23. The sealing assembly as recited in claim 16 wherein the projections are struts, and the seal structure also has a filler material, the struts being embedded in the filler material and holding the same on the seal carrier.

24. The sealing assembly as recited in claim 16 wherein the projections are web walls, together, defining cavities open in each case to a side opposite the seal carrier.

25. The sealing assembly as recited in claim 24 wherein the web walls are each solid bodies, thus each extend continuously without discontinuity between the mutually opposing outer wall surfaces thereof.

26. A module for a turbomachine comprising the sealing assembly as recited in claim 16 and a sealing part moving during operation relative thereto.

27. The module as recited in claim 26 wherein the module radially defines a gas duct of the turbomachine, the sealing assembly being configured radially inside of the gas duct.

28. The module as recited in claim 26 wherein the sealing assembly is suspended radially within an inner platform of a guide vane ring of the module and positionally fixed relative to the guide vane ring, the sealing part being positionally fixed relative to a rotor blade ring of the module.

29. A turbomachine comprising the sealing assembly as recited in claim 16.

30. A jet engine comprising the sealing assembly as recited in claim 16.

31. A method for manufacturing the sealing assembly as recited in claim 16, wherein the projections of the seal structure are built-up additively.
